(19) United States
(12) Patent Application Publication
(10) Pub. No.: US 2026/0349941 A1
(43) Pub. Date: Nov. 5, 2026

(54) BASEBOARD MANAGEMENT CONTROLLER, AND BASIC INPUT/OUTPUT SYSTEM DEBUGGING METHOD AND APPARATUS

(71) Applicant: SUZHOU METABRAIN INTELLIGENT TECHNOLOGY CO., LTD., Suzhou, Jiangsu (CN)

(72) Inventors: Jinfeng LI, Suzhou, Jiangsu (CN); Xinglong WANG, Suzhou, Jiangsu (CN); Qingwei ZHAI, Suzhou, Jiangsu (CN); An WU, Suzhou, Jiangsu (CN)

(21) Appl. No.: 19/120,731

(22) PCT Filed: Jun. 24, 2024
(86) PCT No.: PCT/CN2024/101007

§ 371 Date: Apr. 11, 2025

(30) Foreign Application Priority Data
Jul. 26, 2023 (CN) 202310923265.8

(51) Int. Cl. G06F 13/20; G06F 13/16; H04L 9/08

(52) U.S. Cl. CPC G06F 13/20; G06F 13/1668; H04L 9/0822

(57) ABSTRACT

The present disclosure provides a baseboard management controller. The baseboard management controller includes: a target bus connected to a central processing unit and configured to obtain an access request sent by the central processing unit; a system bus and a dynamic random access memory hooked on the system bus, where the dynamic random access memory is configured to store a first basic input/output system image; a bus agent hooked on the system bus and configured to configure a first address range to a preset register and forward the access request to a memory controller hooked on the system bus based on the first address range, where the first address range is an address range of the first basic input/output system image in a bus address space of the system bus; the memory controller is configured to access the first basic input/output system image in the dynamic random access memory.

### CROSS-REFERENCE TO RELATED APPLICATION

The present disclosure claims the priority of Chinese patent application number 202310923265.8, filed with the CNIPA, China National Intellectual Property Administration, on Jul. 26, 2023, and entitled “BASEBOARD MANAGEMENT CONTROLLER, AND BASIC INPUT/OUTPUT SYSTEM DEBUGGING METHOD AND APPARATUS”, which is incorporated herein in its entirety by reference.

### FIELD

The present disclosure relates to the field of basic input/output system debugging technologies, and more particularly to a baseboard management controller, and a basic input/output system debugging method and apparatus.

### BACKGROUND

In a research and development stage of a basic input/output system (BIOS) of a server product, it is necessary to debug new versions of the BIOS frequently because of developing new functions and analyzing problems. At present, in a debugging process under a common BIOS storage architecture, there are some problems that a flash memory (Flash) needs to be removed and plugged into a programmer or a special fixture is used to refresh the BIOS, which is inefficient; and the BIOS refresh speed is slow, which reduces the debugging efficiency.

### SUMMARY

In view of this, the purpose of the present disclosure is to provide a baseboard management controller, and a basic input/output system debugging method and apparatus, which may improve the debugging efficiency of the basic input/output system. The specific solutions are as follows.

In a first aspect, the present disclosure discloses a baseboard management controller, including:
a target bus connected to a central processing unit and configured to obtain an access request sent by the central processing unit;
a system bus and a dynamic random access memory hooked on the system bus, where the dynamic random access memory is configured to store a first basic input/output system image; and
a bus agent hooked on the system bus and configured to configure a first address range to a preset register and forward the access request to a memory controller hooked on the system bus based on the first address range, where the first address range is an address range of the first basic input/output system image in a bus address space of the system bus; and
the memory controller is configured to access the first basic input/output system image in the dynamic random access memory.

In some embodiments, the baseboard management controller further includes:
a network controller hooked on the system bus and configured to obtain the first basic input/output system image through an out-of-band interface of the baseboard management controller; and
a core component hooked on the system bus and configured to store the first basic input/output system image to the dynamic random access memory.

In some embodiments, the baseboard management controller further includes:
a core component hooked on the system bus and configured to create a virtual basic input/output system image in the dynamic random access memory as the first basic input/output system image.

In some embodiments, the bus agent is further configured to:
in response to the access request being a read request, send a first interrupt notification to a preset service in the core component to send a data request to a user terminal through the preset service;
the baseboard management controller further includes: a network controller hooked on the system bus and configured to obtain read data returned by the user terminal; and the core component is further configured to write the read data into the first basic input/output system image, where the read data is data read from a second basic input/output system image, and the second basic input/output system image is an image preloaded into a memory by the user terminal.

In some embodiments, the bus agent is further configured to:
in response to the access request being a write request, write write data carried in the write request into the first basic input/output system image and send a second interrupt notification to the preset service in the core component to read the write data from the first basic input/output system image through the preset service and send the write data to the user terminal to enable the user terminal to write the write data into the second basic input/output system image preloaded into the memory of the user terminal.

In some embodiments, the baseboard management controller further includes:
a flash memory controller hooked on the system bus and configured to access a basic input/output system flash memory hooked on the flash memory controller.

In some embodiments, the core component is further configured to program the flash memory controller to write the first basic input/output system image in the dynamic random access memory into the basic input/output system flash memory.

In some embodiments, the core component is further configured to: fetch data in the basic input/output system flash memory into the dynamic random access memory, and establish a third basic input/output system image in the dynamic random access memory based on the data;
configure a second address range of the third basic input/output system image in the bus address space to the preset register; and
access the third basic input/output system image in the dynamic random access memory based on the second address range in response to obtaining an access request for the basic input/output system flash memory sent by the central processing unit.

In a second aspect, the present disclosure discloses a basic input/output system debugging method, applied to a baseboard management controller, where the baseboard management controller is connected to a central processing unit through a target bus, and a basic input/output system flash memory and a dynamic random access memory are hooked on a system bus of the baseboard management controller, the method including:
configuring a first address range to a preset register, where the first address range is an address range of a first basic input/output system image in the dynamic random access memory in a bus address space of the system bus; and
in response to obtaining an access request for the basic input/output system flash memory sent by the central processing unit through the target bus, accessing the first basic input/output system image in the dynamic random access memory based on the first address range to realize debugging of a basic input/output system.

In some embodiments, before configuring the first address range to the preset register, the method further includes:
obtaining the first basic input/output system image through an out-of-band interface of the baseboard management controller, and storing the first basic input/output system image to the dynamic random access memory.

In some embodiments, after obtaining the first basic input/output system image, the method further includes:
parsing layout information of the first basic input/output system image, where the layout information includes position information and size information on non-transitory data sections;
backing up data of the non-transitory data sections in the first basic input/output system image based on the layout information to obtain backup data; and
overwriting current data of the non-transitory data sections in the first basic input/output system image based on the backup data in response to obtaining a default value recovery request.

In some embodiments, the method further includes:
obtaining a signature of the first basic input/output system image uploaded by a user terminal, where the signature is obtained by encrypting a hash value of the first basic input/output system image using an encrypted private key;
decrypting the signature using a public key to obtain decrypted data; and
obtaining a hash value of the first basic input/output system image uploaded by the user terminal, verifying the hash value using the decrypted data, and triggering the step of obtaining the first basic input/output system image through the out-of-band interface of the baseboard management controller in response to a success of the verifying.

In some embodiments, the method further includes:
in response to the dynamic random access memory including different first basic input/output system images,
configuring a plurality of groups of preset registers based on address ranges of the different first basic input/output system images in the bus address space;
setting a preset register corresponding to a chip select signal to be valid based on the chip select signal enabled by the central processing unit; and
obtaining the access request sent by the central processing unit, and accessing a first basic input/output system image corresponding to the valid preset register in the dynamic random access memory.

In some embodiments, before configuring the first address range to the preset register, the method further includes:
creating a virtual basic input/output system image in the dynamic random access memory as the first basic input/output system image.

In some embodiments, in response to the access request being a read request, the method further includes:
sending a first interrupt notification to a preset service to send a data request to a user terminal through the preset service, obtaining read data returned by the user terminal, and writing the read data into the first basic input/output system image,
where the read data is data read from a second basic input/output system image, and the second basic input/output system image is an image preloaded into a memory by the user terminal.

In some embodiments, in response to the access request being a write request, the method further includes:
writing write data carried in the write request into the first basic input/output system image, sending a second interrupt notification to a preset service to read the write data from the first basic input/output system image through the preset service and send the write data to the user terminal to enable the user terminal to write the write data into a second basic input/output system image preloaded into a memory of the user terminal.

In some embodiments, the method further includes:
collecting all the access requests through a preset service, and sending the access requests to a user terminal to enable the user terminal to log based on the access requests.

In some embodiments, the method further includes:
obtaining a signature of the second basic input/output system image uploaded by the user terminal, where the signature is obtained by encrypting a hash value of the second basic input/output system image using an encrypted private key;
decrypting the signature using a public key to obtain decrypted data; and
obtaining a hash value of the second basic input/output system image uploaded by the user terminal, verifying the hash value using the decrypted data, and triggering the step of creating the virtual basic input/output system image in the dynamic random access memory in response to a success of the verifying.

In some embodiments, the method further includes:
receiving a client program download request sent by the user terminal, and returning a client program in response to the client program download request,
where obtaining the signature of the second basic input/output system image uploaded by the user terminal includes:
obtaining the signature of the second basic input/output system image uploaded by a client through the preset service, where the client is a client launched by the user terminal based on the client program.

In some embodiments, a memory controller is hooked on the system bus, the dynamic random access memory is hooked on the memory controller, and accessing the first basic input/output system image in the dynamic random access memory based on the first address range includes:
sending the access request to the memory controller, and accessing the first basic input/output system image in the dynamic random access memory through the memory controller.

In some embodiments, the method further includes:
in response to the preset register being in a default configuration, obtaining the access request for the basic input/output system flash memory sent by the central processing unit through the target bus, and accessing the basic input/output system flash memory.

In some embodiments, a flash memory controller is hooked on the system bus, the basic input/output system flash memory is hooked on the flash memory controller, and accessing the basic input/output system flash memory includes:
sending the access request to the flash memory controller, and accessing the basic input/output system flash memory through the flash memory controller.

In some embodiments, the method further includes:
obtaining the first basic input/output system image through an out-of-band interface of the baseboard management controller, and storing the first basic input/output system image to the dynamic random access memory; and
programming the flash memory controller to write the first basic input/output system image in the dynamic random access memory into the basic input/output system flash memory.

In some embodiments, the method further includes:
fetching data in the basic input/output system flash memory into the dynamic random access memory, and establishing a third basic input/output system image in the dynamic random access memory based on the data;
configuring a second address range of the third basic input/output system image in the bus address space to the preset register; and
accessing the third basic input/output system image in the dynamic random access memory based on the second address range in response to obtaining the access request for the basic input/output system flash memory sent by the central processing unit.

In some embodiments, the method further includes:
mapping different basic input/output system flash memories to the bus address space of the system bus, where address ranges of the different basic input/output system flash memories in the bus address space are different;
configuring a plurality of groups of preset registers based on the address ranges of the different basic input/output system flash memories in the bus address space;
setting a preset register corresponding to a chip select signal to be valid based on the chip select signal enabled by the central processing unit; and
obtaining the access request sent by the central processing unit, and accessing a basic input/output system flash memory corresponding to the valid preset register.

In some embodiments, a network controller is hooked on the system bus and is configured to interconnect with an external network.

In some embodiments, a bus agent is hooked on the system bus, the bus agent is connected to the central processing unit through the target bus, and the method further includes:
configuring the preset register through the bus agent, obtaining the access request sent by the central processing unit, and forwarding the access request to a corresponding component hooked on the system bus based on the configuration of the preset register.

In a third aspect, the present disclosure discloses a basic input/output system debugging apparatus, applied to a baseboard management controller, where the baseboard management controller is connected to a central processing unit through a target bus, and a basic input/output system flash memory and a dynamic random access memory are hooked on a system bus of the baseboard management controller, the apparatus including:
a register configuration module configured to configure a first address range to a preset register, where the first address range is an address range of a first basic input/output system image in the dynamic random access memory in a bus address space of the system bus;
an access request obtaining module configured to obtain an access request for the basic input/output system flash memory sent by the central processing unit through the target bus; and
an image access module configured to access the first basic input/output system image in the dynamic random access memory based on the first address range to realize debugging of a basic input/output system.

It can be seen that the baseboard management controller provided in the present disclosure includes a target bus connected to a central processing unit and configured to obtain an access request sent by the central processing unit; a system bus and a dynamic random access memory hooked on the system bus, where the dynamic random access memory is configured to store a first basic input/output system image; and a bus agent hooked on the system bus and configured to configure a first address range to a preset register and forward the access request to a memory controller hooked on the system bus based on the first address range, where the first address range is an address range of the first basic input/output system image in a bus address space of the system bus; and the memory controller is configured to access the first basic input/output system image in the dynamic random access memory.

The beneficial effects of the present disclosure are in that the central processing unit is controlled by the baseboard management controller to be connected to the data bus of the basic input/output system flash memory, and the access request of the central processing unit is mapped to the dynamic random access memory, thereby realizing the debugging of the basic input/output system. In this way, it is not necessary to remove or plug the flash memory into the programmer or use the special fixture to refresh the basic input/output system, and it is not necessary to erase the flash memory first and then write the flash memory, thereby avoiding the problem that the refreshing of the basic input/output system takes a long time, and improving the debugging efficiency of the basic input/output system.

### BRIEF DESCRIPTION OF THE DRAWINGS

In order to more clearly explain the technical solutions in the embodiments of the present disclosure, accompanying drawings that are required to be used in the embodiments or the related art will be briefly introduced below. Obviously, the accompanying drawings described below are merely some embodiments of the present disclosure, and a person skilled in the art may obtain other accompanying drawings according to these accompanying drawings without paying creative labor.

FIG. 1 is a schematic diagram of a basic input/output system (BIOS) storage architecture in the related art.

FIG. 2 is a schematic diagram of another basic input/output system (BIOS) storage architecture in the related art.

FIG. 3 is a schematic diagram of yet another basic input/output system (BIOS) storage architecture in the related art.

FIG. 4 is a schematic diagram of still another basic input/output system (BIOS) storage architecture in the related art.

FIG. 5 is a schematic structural diagram of a baseboard management controller disclosed in some embodiments of the present disclosure.

FIG. 6 is a schematic diagram of an internal structure of a bus agent disclosed in some embodiments of the present disclosure.

FIG. 7 is a flowchart of a basic input/output system debugging method disclosed in some embodiments of the present disclosure.

FIG. 8 is a schematic diagram of a basic access function of a basic input/output system (BIOS) flash memory (Flash) disclosed in some embodiments of the present disclosure.

FIG. 9 is a schematic diagram of a function of an out-of-band refresh basic input/output system (BIOS) flash memory (Flash) disclosed in some embodiments of the present disclosure.

FIG. 10 is a schematic diagram of a memory-based basic input/output system (BIOS) debugging method disclosed in some embodiments of the present disclosure.

FIG. 11 is a schematic diagram of a network-based basic input/output system (BIOS) debugging method disclosed in some embodiments of the present disclosure.

FIG. 12 is a schematic diagram of an access log format of a basic input/output system (BIOS) flash memory (Flash) disclosed in some embodiments of the present disclosure.

FIG. 13 is a schematic diagram of a fast basic input/output system (BIOS) flash memory (Flash) access disclosed in some embodiments of the present disclosure.

FIG. 14 is a schematic diagram of a dual basic input/output system (BIOS) flash memory (Flash) disclosed in some embodiments of the present disclosure.

FIG. 15 is a schematic diagram of a bus agent disclosed in some embodiments of the present disclosure.

FIG. 16 is a schematic diagram of another dual basic input/output system (BIOS) flash memory (Flash) disclosed in some embodiments of the present disclosure.

FIG. 17 is a schematic diagram of a security mechanism disclosed in some embodiments of the present disclosure.

FIG. 18 is a schematic structural diagram of a basic input/output system debugging apparatus disclosed in some embodiments of the present disclosure.

### DETAILED DESCRIPTION

Technical solutions in some embodiments of the present disclosure will be clearly and completely described below in combination with accompanying drawings in some embodiments of the present disclosure. Obviously, the described embodiments are merely a part of the embodiments of the present disclosure, rather than all of the embodiments. All of the other embodiments that a person skilled in the art obtains on the basis of the embodiments of the present disclosure without paying creative labor fall within the protection scope of the present disclosure.

In the research and development stage of a basic input/output system (BIOS) of a server product, it is necessary to debug new versions of the BIOS frequently because of developing new functions and analyzing problems. The storage architecture and update manner of the BIOS have great influence on the debugging efficiency of the BIOS. The BIOS should be stored in a non-transitory readable storage medium that can be directly accessed by a central processing unit (CPU) in an initial power-on phase, usually in a flash memory (Flash). The CPU reads and writes the Flash through an interface such as a low pin count (LPC) interface, a serial peripheral interface (SPI) or an enhanced SPI (eSPI). When testing a new version of BIOS, it is generally necessary to write the new BIOS into the Flash before it can be run. The speed of updating the BIOS affects the efficiency of the BIOS development and debugging. There are four types of existing BIOS storage architectures, which correspond to different update methods.

Type 1: referring to FIG. 1, FIG. 1 is a schematic diagram of a basic input/output system (BIOS) storage architecture in the related art. The BIOS is directly connected to CPU or chipset through an SPI bus. Taking CPU 0 and CPU 1 as examples, this architecture supports three BIOS update solutions: 1) a basic input/output system flash memory (BIOS Flash) is taken out of a motherboard card slot, and is refreshed offline by using a flash programmer; 2) a programming socket is reserved on a motherboard, and a programmer is connected to the socket to program the BIOS Flash; 3) after a host (Host) is started, the BIOS Flash is refreshed in the band by programming a SPI bus controller.

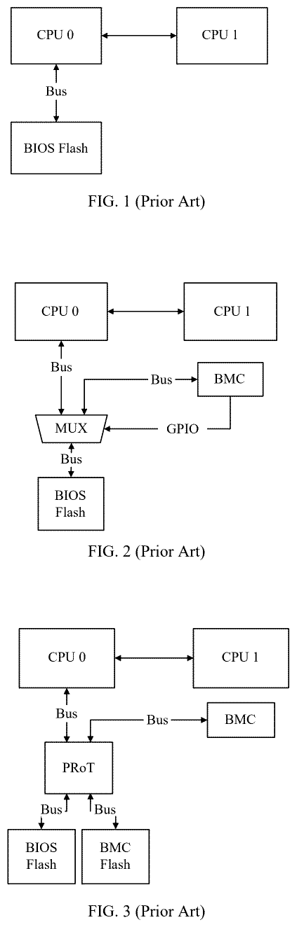

Type 2: referring to FIG. 2, FIG. 2 is a schematic diagram of another basic input/output system (BIOS) storage architecture in the related art. On the basis of Type 1 solution, a multiplexer (MUX) chip is added between the CPU and the BIOS Flash to control whether an SPI bus of the BIOS Flash is connected to the CPU or to a baseboard management controller (BMC) through a strobe signal of the MUX chip. The strobe signal of the MUX chip is controlled by a general purpose input output (GPIO) pin of the BMC. Buses in FIG. 2 all refer to SPI buses. Under this architecture, in addition to supporting the three BIOS update solutions supported by Type 1, it also supports refreshing the BIOS Flash through the BMC, that is, an out-of-band refresh BIOS function is supported.

Type 3: referring to FIG. 3, FIG. 3 is a schematic diagram of yet another basic input/output system (BIOS) storage architecture in the related art. It has an independent platform firmware resilience (PFR) architecture of a platform root of trust (PROT). The buses in FIG. 3 refer to the SPI buses. Under this architecture, the BIOS update solutions supported by Type 3are the same as the BIOS update solutions supported by Type 2, but the process details are different when performing out-of-band refresh. When performing the out-of-band refresh through the BMC, due to the requirements of the PFR architecture, the BMC does not directly write the new version of BIOS to the BIOS Flash, but temporarily stores the new version of BIOS to a reserved space of a BMC Flash first, and then the BMC informs the PROT that there is a BIOS update task; and when the system restarts, the PROT reads the new version of BIOS file from the BMC Flash, and updates the BIOS file into the BIOS Flash.

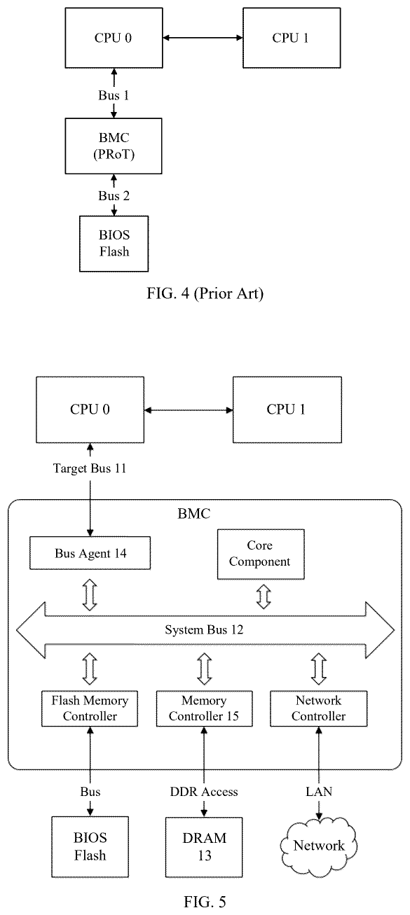

Type 4: referring to FIG. 4, FIG. 4 is a schematic diagram of still another basic input/output system (BIOS) storage architecture in the related art. The BMC serves as the PFR architecture of the PROT. Under this architecture, all update solutions of Type 2 architecture are supported, and since the BMC itself is the PROT, an intermediate temporary storage stage of Type 3 architecture is avoided when performing the out-of-band refresh.

The disadvantage of Type 1 architecture is that when the system fails to start due to a failure of the BIOS, an in-band refresh solution cannot be used, and only the programmer can be used to refresh the BIOS, which requires developers to remove the Flash at the machine site, or plug in the programmer, or use a special fixture to refresh, which is very inefficient. The main disadvantage of Type 2, Type 3 and Type 4 architectures is the low update speed. With the increasing complexity of BIOS functions, the capacity of the BIOS Flash has become huge. The typical capacity of the BIOS Flash in current servers is 64 MB (megabytes) or 128 MB. At the same time, due to the inherent erase-before-write characteristics of Flash itself, it takes several minutes to completely update. When BIOS is required to iterate and verify quickly, it cannot meet the time requirement of project development. Especially under the PFR architecture, it takes longer to refresh the BIOS because of the existence of the intermediate temporary storage stage. That is, there is a problem of low debugging efficiency of the BIOS at present. Therefore, the present disclosure provides a basic input/output system debugging method, which may improve the debugging efficiency of the basic input/output system.

Referring to FIG. 5, some embodiments of the present disclosure disclose a baseboard management controller, including:
a target bus 11 connected to a central processing unit and configured to obtain an access request sent by the central processing unit;
a system bus 12 and a dynamic random access memory 13 hooked on the system bus, where the dynamic random access memory is configured to store a first basic input/output system image; and
a bus agent 14 hooked on the system bus and configured to configure a first address range to a preset register and forward the access request to a memory controller 15 hooked on the system bus based on the first address range, where the first address range is an address range of the first basic input/output system image in a bus address space of the system bus; and
the memory controller 15 is configured to access the first basic input/output system image in the dynamic random access memory.

It can be seen that in some embodiments of the present disclosure, the central processing unit is controlled by the baseboard management controller to be connected to the data bus of the basic input/output system flash memory, and the access request of the central processing unit is mapped to the dynamic random access memory, thereby realizing the debugging of the basic input/output system. In this way, it is not necessary to remove or plug the flash memory into the programmer or use the special fixture to refresh the basic input/output system, and it is not necessary to erase the flash memory first and then write the flash memory, thereby avoiding the problem that the refreshing of the basic input/output system takes a long time, and improving the debugging efficiency of the basic input/output system.

In some embodiments, the baseboard management controller further includes:
a network controller hooked on the system bus and configured to obtain the first basic input/output system image through an out-of-band interface of the baseboard management controller; and
a core component hooked on the system bus and configured to store the first basic input/output system image to the dynamic random access memory.

It can be understood that in the present disclosure, an address range of the dynamic random access memory may be mapped to the bus address space, and when the basic input/output system image is stored in the dynamic random access memory, an address range of the image in the bus address space may be determined.

In an implementation manner, the core component hooked on the system bus is further configured to create a virtual basic input/output system image in the dynamic random access memory as the first basic input/output system image. Correspondingly, the bus agent is further configured to:
in response to the access request being a read request, send a first interrupt notification to a preset service in the core component to send a data request to a user terminal through the preset service;
the network controller hooked on the system bus is further configured to obtain read data returned by the user terminal; and the core component is further configured to write the read data into the first basic input/output system image, where the read data is data read from a second basic input/output system image, and the second basic input/output system image is an image preloaded into a memory by the user terminal.

The bus agent is further configured to: in response to the access request being a write request, write write data carried in the write request into the first basic input/output system image and send a second interrupt notification to the preset service in the core component to read the write data from the first basic input/output system image through the preset service and send the write data to the user terminal to enable the user terminal to write the write data into the second basic input/output system image preloaded into the memory of the user terminal.

In some embodiments, the baseboard management controller further includes:
a flash memory controller hooked on the system bus and configured to access a basic input/output system flash memory hooked on the flash memory controller. That is, an access function for the basic input/output system flash memory is provided in some embodiments of the present disclosure.

Correspondingly, the core component is further configured to program the flash memory controller to write the first basic input/output system image in the dynamic random access memory into the basic input/output system flash memory. That is, an out-of-band refresh function for the basic input/output system flash memory is provided.

In some embodiments, the core component is further configured to: fetch data in the basic input/output system flash memory into the dynamic random access memory, and establish a third basic input/output system image in the dynamic random access memory based on the data;
configure a second address range of the third basic input/output system image in the bus address space to the preset register; and
access the third basic input/output system image in the dynamic random access memory based on the second address range in response to obtaining an access request for the basic input/output system flash memory sent by the central processing unit. That is, fast access to the basic input/output system flash memory may be implemented in some embodiments of the present disclosure.

It can be understood that in some embodiments of the present disclosure, the BMC is connected to the CPU through the SPI or eSPI bus (that is, the target bus), and serves as a slave device of the SPI or eSPI. The BIOS Flash is hooked on the BMC, taking CPU 0 and CPU 1 as examples. In addition, there is also a memory and a network on the periphery of the BMC chip. The BMC includes the following components.

System bus: it is an internal system bus of the BMC chip, and all functional components in the BMC are connected to this bus. Some components can be used as bus master devices to initiate a system bus access, and some components can only be used as bus slave devices to respond access from other components.

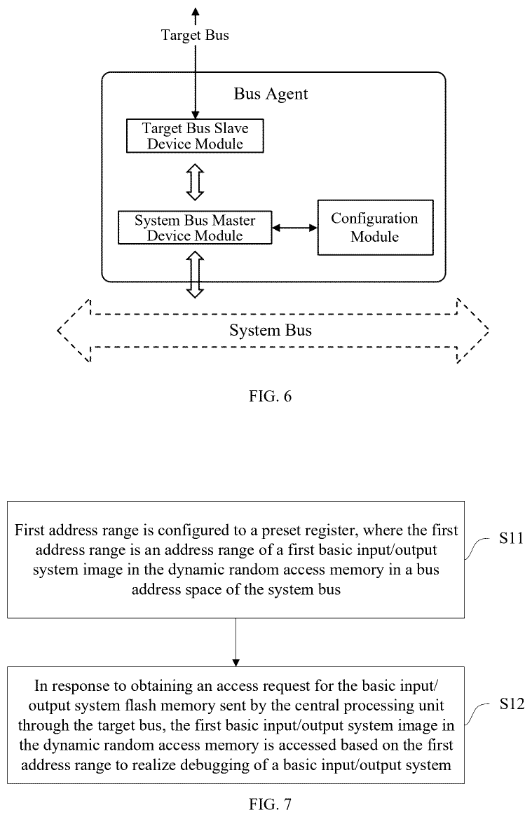

Bus agent: referring to FIG. 6, FIG. 6 is a schematic diagram of an internal structure of a bus agent provided in some embodiments of the present disclosure. The bus agent includes three modules, and the target bus is an SPI/eSPI bus. A target bus slave device module is responsible for connecting to an external target bus master device, converting an SPI/eSPI bus access request into a BMC system bus access request, and forwarding the BMC system bus access request to a system bus master device module. A configuration module provides a software programming interface that can be programmed to influence how a system bus master device works. The system bus master device module is responsible for initiating a BMC system bus access request, and sending the request from the target bus slave device module to different components in the BMC according to information provided by the configuration module. A BIOS Flash access request can be mapped to a BMC address space through the configuration module. The BMC distinguishes whether to access a flash memory or to access a memory by the difference in the address ranges of the BIOS flash and the BIOS image in the memory mapped to the address space.

Flash memory controller: it is a controller for an SPI or eSPI interface, and is connected between the system bus of the BMC and the BIOS Flash. Memory controller: it is a controller for the BMC to access a memory, which can access the dynamic random access memory at a double data rate (DDR). Network controller: the BMC is interconnected with an external network through the network controller to provide an out-of-band access interface, where the network can be a local area network (LAN).

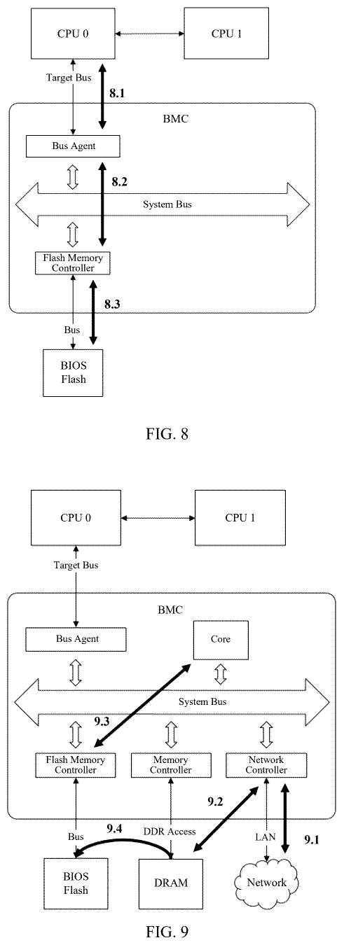

Referring to FIG. 7, some embodiments of the present disclosure disclose a basic input/output system debugging method. The method is applied to a baseboard management controller, where the baseboard management controller is connected to a central processing unit through a target bus, and a basic input/output system flash memory and a dynamic random access memory are hooked on a system bus of the baseboard management controller. The method includes the following steps.

Step S11, a first address range is configured to a preset register, where the first address range is an address range of a first basic input/output system image in the dynamic random access memory in a bus address space of the system bus.

In some embodiments of the present disclosure, the target bus may be an SPI bus or an eSPI bus.

In a specific embodiment, a network controller is hooked on the system bus, and is used to interconnect with an external network and provide an out-of-band interface.

In an implementation manner, before configuring the first address range to the preset register, the first basic input/output system image can be obtained through an out-of-band interface of the baseboard management controller, and the first basic input/output system image is stored to the dynamic random access memory. That is, the first basic input/output system image can be obtained through the out-of-band interface provided by the network controller.

In some embodiments of the present disclosure, a signature of the first basic input/output system image uploaded by a user terminal can be obtained, where the signature is obtained by encrypting a hash value of the first basic input/output system image using an encrypted private key; the signature is decrypted using a public key to obtain decrypted data; and a hash value of the first basic input/output system image uploaded by the user terminal is obtained, the hash value is verified using the decrypted data, and the step of obtaining the first basic input/output system image through the out-of-band interface of the baseboard management controller is triggered in response to a success of the verifying.

In addition, in some embodiments of the present disclosure, after obtaining the first basic input/output system image, the method further includes: parsing layout information of the first basic input/output system image, where the layout information includes position information and size information on non-transitory data sections; backing up data of the non-transitory data sections in the first basic input/output system image based on the layout information to obtain backup data; and overwriting current data of the non-transitory data sections in the first basic input/output system image based on the backup data in response to obtaining a default value recovery request. The non-transitory data sections are configured to store data such as options configured by users.

In another implementation, in some embodiments of the present disclosure, before configuring the first address range to the preset register, a virtual basic input/output system image is created in the dynamic random access memory as the first basic input/output system image.

In some embodiments of the present disclosure, a signature of the second basic input/output system image uploaded by the user terminal can be obtained, where the signature is obtained by encrypting a hash value of the second basic input/output system image using an encrypted private key; the signature is decrypted using a public key to obtain decrypted data; and a hash value of the second basic input/output system image uploaded by the user terminal is obtained, the hash value is verified using the decrypted data, and the step of creating the virtual basic input/output system image in the dynamic random access memory is triggered in response to a success of the verifying.

In some embodiments of the present disclosure, a client program download request sent by the user terminal can be received, and a client program is returned in response to the client program download request, correspondingly, the signature of the second basic input/output system image uploaded by a client is obtained through the preset service, where the client is a client launched by the user terminal based on the client program.

In a specific implementation, two preset registers (that is, a group of preset registers) can be configured, where one of the two preset registers is a base address register for configuring a start address of the first address range, and the other is a range register for configuring a range size of the first address range.

Step S12, in response to obtaining an access request for the basic input/output system flash memory sent by the central processing unit through the target bus, the first basic input/output system image in the dynamic random access memory is accessed based on the first address range to realize debugging of a basic input/output system.

In a specific implementation manner, the access request can be sent to the memory controller, and the first basic input/output system image in the dynamic random access memory is accessed through the memory controller.

In some embodiments, when the image in the dynamic random access memory is the virtual basic input/output system image, in response to the access request being a read request, in some embodiments of the present disclosure, a first interrupt notification is sent to a preset service to send a data request to a user terminal through the preset service, read data returned by the user terminal is obtained, and the read data is written into the first basic input/output system image, and the read data is written into the first basic input/output system image, where the read data is data read from a second basic input/output system image, and the second basic input/output system image is an image preloaded into a memory by the user terminal. In response to the access request being a write request, in some embodiments of the present disclosure, write data carried in the write request is written into the first basic input/output system image, a second interrupt notification is sent to a preset service to read the write data from the first basic input/output system image through the preset service and send the write data to the user terminal to enable the user terminal to write the write data into a second basic input/output system image preloaded into a memory of the user terminal.

In some embodiments of the present disclosure, all the access requests can be collected through a preset service, and the access requests is sent to a user terminal to enable the user terminal to log based on the access requests.

In addition, in some embodiments of the present disclosure, in response to the dynamic random access memory including different first basic input/output system images, and the different first basic input/output system images having different address ranges in the bus address space, configuring a plurality of groups of preset registers based on address ranges of the different first basic input/output system images in the bus address space; setting a preset register corresponding to a chip select signal to be valid based on the chip select signal enabled by the central processing unit; and obtaining the access request sent by the central processing unit, and accessing a first basic input/output system image corresponding to the valid preset register in the dynamic random access memory. That is, in the present disclosure, the plurality of different first basic input/output system images may be obtained based on the out-of-band interface of the baseboard management controller, and then the plurality of different first basic input/output system images are stored to the dynamic random access memory. In addition, a plurality of virtual basic input/output system images may also be created in the dynamic random access memory as the plurality of first basic input/output system images, and the plurality of groups of preset registers are configured based on the plurality of first basic input/output system images.

In addition, in some embodiments of the present disclosure, in response to the preset register being in a default configuration, the access request for the basic input/output system flash memory sent by the central processing unit is obtained through the target bus, and the basic input/output system flash memory is accessed. That is, in some embodiments of the present disclosure, an access function for the basic input/output system flash memory is provided. Furthermore, a flash memory controller is hooked on the system bus, the access request can be sent to the flash memory controller, and then the basic input/output system flash memory can be accessed through the flash memory controller.

In some embodiments of the present disclosure, the first basic input/output system image can be obtained through an out-of-band interface of the baseboard management controller, and the first basic input/output system image is stored to the dynamic random access memory; and the flash memory controller is programmed to write the first basic input/output system image in the dynamic random access memory into the basic input/output system flash memory. That is, the method provides a function of out-of-band refresh for the basic input/output system flash memory.

In some embodiments of the present disclosure, data in the basic input/output system flash memory can be fetched into the dynamic random access memory, and a third basic input/output system image is established in the dynamic random access memory based on the data; a second address range of the third basic input/output system image in the bus address space is configured to the preset register; and the third basic input/output system image in the dynamic random access memory is accessed based on the second address range in response to obtaining the access request for the basic input/output system flash memory sent by the central processing unit. When the startup is completed, the current third basic input/output system image is synchronized to the basic input/output system flash memory. That is, in some embodiments of the present disclosure, fast access to the basic input/output system flash memory may be realized.

Further, in some embodiments of the present disclosure, different basic input/output system flash memories can be mapped to the bus address space of the system bus, where address ranges of the different basic input/output system flash memories in the bus address space are different; a plurality of groups of preset registers are configured based on the address ranges of the different basic input/output system flash memories in the bus address space; a preset register corresponding to a chip select signal is set to be valid based on the chip select signal enabled by the central processing unit; and the access request sent by the central processing unit is obtained, and a basic input/output system flash memory corresponding to the valid preset register is accessed. That is, a plurality of basic input/output system flash memories are supported in some embodiments of the present disclosure.

In some embodiments of the present disclosure, a bus agent is hooked on the system bus, the bus agent is connected to the central processing unit through the target bus. Correspondingly, in some embodiments of the present disclosure, the preset register is configured through the bus agent, the access request sent by the central processing unit is obtained, and the access request is forwarded to a corresponding component hooked on the system bus based on the configuration of the preset register.

Further, referring to FIG. 8, FIG. 8 is a schematic diagram of a basic access function of a basic input/output system (BIOS) flash memory (Flash) disclosed in some embodiments of the present disclosure. The function realizes the most basic function of a CPU accessing a BIOS Flash, that is, an SPI/eSPI agent (that is, the bus agent) initiates a system bus request, and forwards a BIOS Flash access request sent by the CPU to a flash memory controller. The working mode is as follows: 8.1, the BIOS Flash access request sent by the CPU is received by the SPI/eSPI agent; 8.2, the SPI/eSPI agent (in a default configuration) initiates a BMC system bus request, and sends the BIOS Flash access request to the flash memory controller; 8.3, the flash memory controller executes the specific Flash access, and returns data in the original path. This embodiment has no influence on the original BIOS Flash update function, and both offline programming and in-band refreshing may work normally.

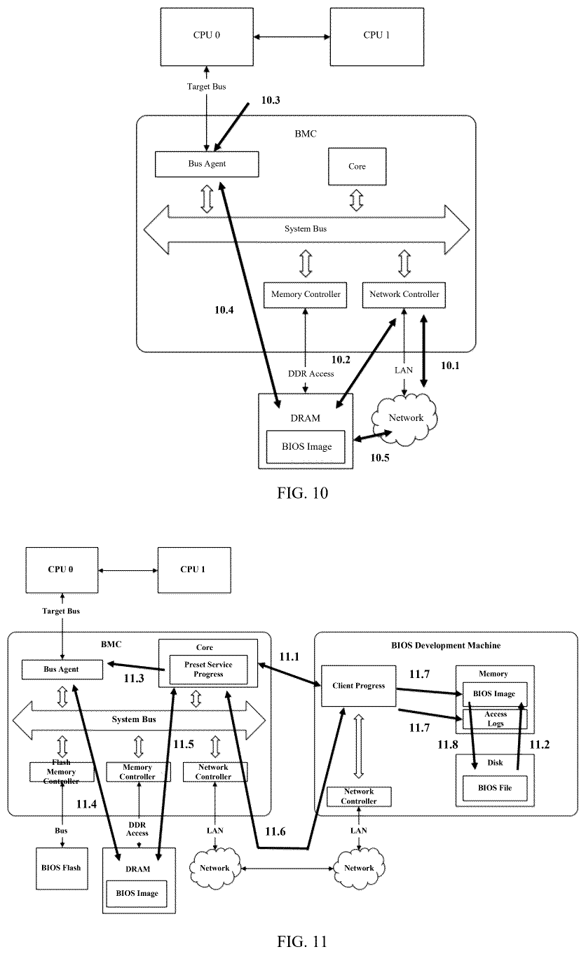

Referring to FIG. 9, FIG. 9 is a schematic diagram of a function of an out-of-band refresh basic input/output system (BIOS) flash memory (Flash) disclosed in some embodiments of the present disclosure. A BIOS image is uploaded to a BMC memory through an out-of-band interface, and the BMC firmware executes the refresh process to update and write the BIOS image to the BIOS Flash. The working mode is as follows: 9.1, a user uses a terminal device to access a Web (that is, World Wide Web) service running on the BMC, and calls an out-of-band refresh interface to initiate a BIOS Flash refresh process; 9.2, after the user uploads a new version of a BIOS image file, the file is stored in the memory by the BMC; 9.3, a refresh program is run on a core of the BMC to program a flash memory controller; 9.4, the BIOS image is written into the BIOS Flash from the memory.

Referring to FIG. 10, FIG. 10 is a schematic diagram of a memory-based basic input/output system (BIOS) debugging method disclosed in some embodiments of the present disclosure. A BIOS image is uploaded to a certain area of a BMC memory through an out-of-band interface, and the BIOS image in a memory is actually executed by configuring an SPI/eSPI agent. The working mode is as follows: 10.1, a memory-based BIOS debugging process is initiated through the out-of-band interface provided by the BMC; 10.2, after uploading a new version of a BIOS image file, the file is stored in a certain area of the memory; 10.3, an base address and size information of the BIOS image in the memory are configured into a register of an SPI/eSPI agent through a configuration module, so that the SPI/eSPI agent is capable of forwarding a BIOS Flash access request to the memory controller; 10.4, the user starts a server to debug the new BIOS image, a BIOS Flash access request sent by the CPU during this process will be forwarded to the memory controller by the SPI/eSPI agent to directly access the BIOS image stored in the memory; 10.5, after the debugging of the BIOS is completed, the user downloads a final state of the BIOS image through the out-of-band interface of the BMC, which is convenient for locating the problem by checking changes of the image.

Further, in some embodiments of the present disclosure, a process related to a BIOS default value may include: 1) the user establishes a connection with a service process on the BMC through a browser on a terminal, and starts a memory-based BIOS debugging process; 2) the user loads a BIOS file, fills in BIOS layout information (including the position and size of non-volatile RAM (NVRAM) sections), and uploads the BIOS file, so that the BIOS image is uploaded to the BMC; 3) the BMC creates a BIOS image in the memory, parses the BIOS layout information, and backs up data of the NVRAM sections for use when restoring the default value; 4) the user initiates a request for restoring the default value through the terminal; 5) the BMC overwrites a part of the BIOS image with the data of the original NVRAM sections backed up before.

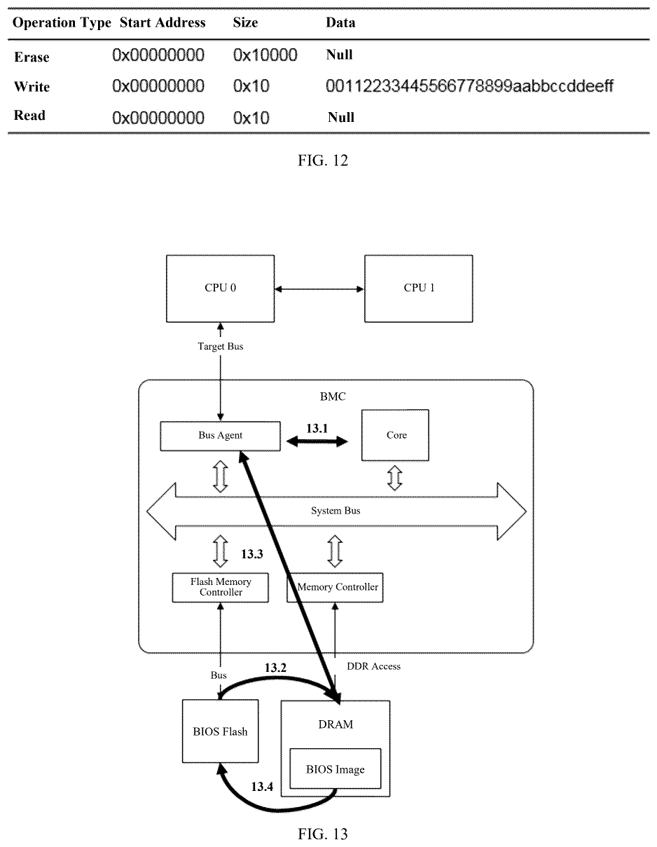

Referring to FIG. 11, FIG. 11 is a schematic diagram of a network-based basic input/output system (BIOS) debugging method disclosed in some embodiments of the present disclosure. The working mode is as follows: 11.1, a user starts a client process on a BIOS development machine (that is, a user terminal), and establishes a connection with a preset service process on a BMC; 11.2, the user selects a BIOS file to be debugged in a disk through the client process and loads the file into a memory; 11.3, the preset service process establishes a virtual BIOS image in a memory of the BMC, and configures a start address and a range into a configuration module of an SPI/eSPI agent, so that the agent forwards a BIOS Flash access request to the memory; 11.4, different processing is performed on BIOS Flash read and write requests: for a read request, the SPI/eSPI agent sends an interrupt to inform the preset service process, the preset service process requests data from a client and fills the requested data in corresponding locations of the virtual BIOS image, after a response of the interrupt is returned, a memory controller returns data in the corresponding locations of the virtual BIOS image to the SPI/eSPI agent; and for a write request, the SPI/eSPI agent writes data into corresponding locations in the virtual BIOS image and sends an interrupt to inform the preset service process, and the preset service process reads data from the corresponding locations in the virtual BIOS image and sends the data to the client; 11.5, an interrupt processing program in the preset service process collects all access requests for the virtual BIOS image sent by the SPI/eSPI agent; 11.6, the preset service process sends all the access requests related to the BIOS image to the client process through the network; 11.7. the client logs all the read requests, and in addition to logging all the write requests, the clients further synchronizes the data to a BIOS image in the memory of the BIOS development machine. Referring to FIG. 12, FIG. 12 is a schematic diagram of an access log format of a basic input/output system (BIOS) flash memory (Flash) disclosed in some embodiments of the present disclosure. The log format may include an operation type, a start address, a size and data. 11.8, the client process writes an updated BIOS image in the memory to a disk file at any time.

Further, in some embodiments of the present disclosure, a process related to a BIOS default value may include: 1) the user establishes a security connection with a preset service on the BMC through a browser on a BIOS development machine, downloads a client program and executes the client program; 2) the user loads a BIOS file through a client process, fills in BIOS layout information (including the position and size of NVRAM sections), and backs up data of the NVRAM sections for use when restoring the default value; 3) the BMC creates a virtual BIOS image in a memory, configures an SPI/eSPI agent and starts debugging; 4) the user initiates a request for restoring the default value through the client; 5) the client overwrites a corresponding portion of the BIOS image with the data of the original NVRAM sections backed up before.

Referring to FIG. 13, FIG. 13 is a schematic diagram of a fast basic input/output system (BIOS) flash memory (Flash) access disclosed in some embodiments of the present disclosure. The working mode is as follows: 13.1, when a BMC is started, a BMC firmware establishes a BIOS image in a memory of the BMC, and configures a start address and a range to a configuration module of an SPI/eSPI agent, so that the SPI/eSPI agent is capable of forwarding an access for a BIOS Flash to the memory; 13.2, the BMC firmware reads data from the BIOS Flash and synchronizes the data to the BIOS image; 13.3, the SPI/eSPI agent forwards a BIOS Flash access request sent by a CPU to a specified area of the memory to access the BIOS image in the memory; 13.4, after the startup is completed, the BIOS firmware synchronizes the BIOS image in the memory to the BIOS Flash.

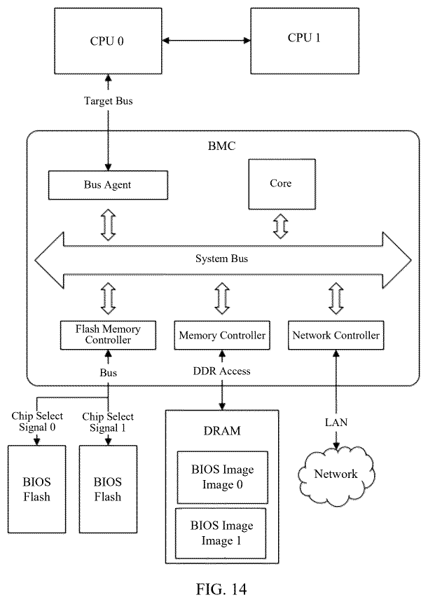

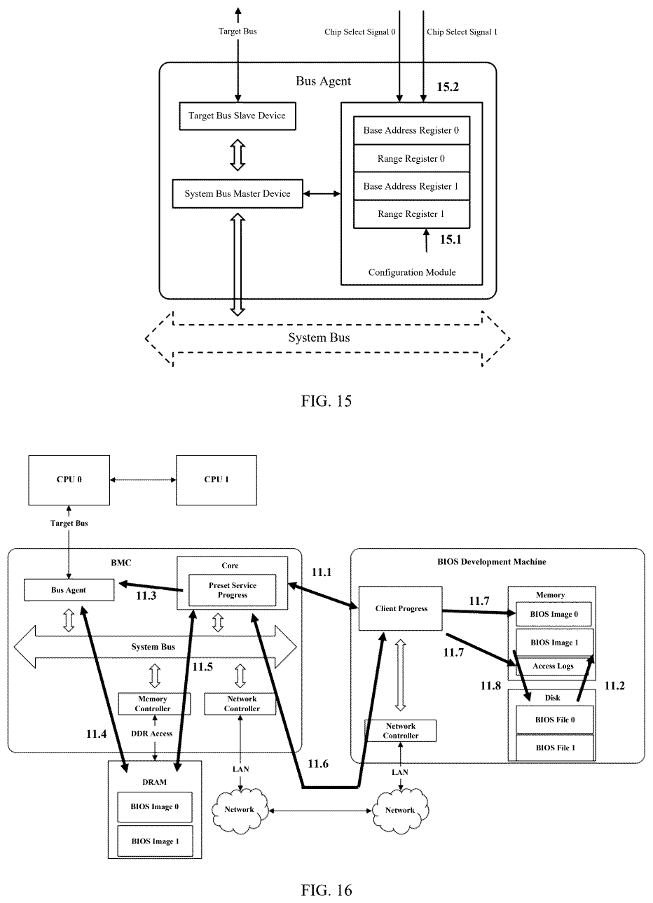

Referring to FIG. 14, FIG. 14 is a schematic diagram of a dual basic input/output system (BIOS) flash memory (Flash) disclosed in some embodiments of the present disclosure. The working mode is as follows: 1) a BMC maps different BIOS Flashes to different addresses in an address space, and two BIOS images in a memory also have different addresses; 2) a configuration module in an SPI/eSPI agent configures two groups of base address/range registers, where these groups of registers record base addresses and ranges of the two BIOS Flashes (or the two BIOS images in the memory) in a BMC address space; 3) when a CPU enables CS0 (chip select signal 0), the configuration module configures CS0_BASE (base address register 0)/CS0_LIMIT (range register 0) to be valid, which means that an access initiated by a BMC bus master device will be mapped to BIOS Flash 0 (or BIOS image 0 in the memory); and when the CPU enables the CS1 (chip select signal 1), the configuration module sets CS1_BASE (base register 1)/CS1_LIMIT (range register 1) to be valid, which means that an access initiated by a BMC bus master device will be mapped to BIOS Flash 1 (or BIOS image 1 in the memory). Referring to FIG. 15, FIG. 15 is a schematic diagram of a bus agent disclosed in some embodiments of the present disclosure. 15.1, two groups of registers are configured; 15.2, registers corresponding to chip select signals are enabled.

Referring to FIG. 16, FIG. 16 is a schematic diagram of another dual basic input/output system (BIOS) flash memory (Flash) disclosed in some embodiments of the present disclosure. Compared with the solution in FIG. 11, the specific working mode of FIG. 16 may refer to the corresponding solution in FIG. 11. In some embodiments of the present disclosure, changes between the solution in FIG. 11 and the solution in FIG. 16 are as follows: 1) the client process on the BIOS development machine needs to load two BIOS files: BIOS file 0 and BIOS file 1, and BIOS image 0 and BIOS image 1 are created in the memory; 2) the preset service process on the BMC creates the BIOS image 0 and the BIOS image 1 in the BMC memory, and configures two groups of registers CS0_BASE/CS0_LIMIT and CS1_BASE/CS1_LIMIT in the SPI/eSPI agent; 3) the preset service process on the BMC monitors all the operations related to the two BIOS images, and synchronizes all the operations to the client process; 4) after the startup is completed, the client process synchronizes two BIOS images in the memory to the disk file.

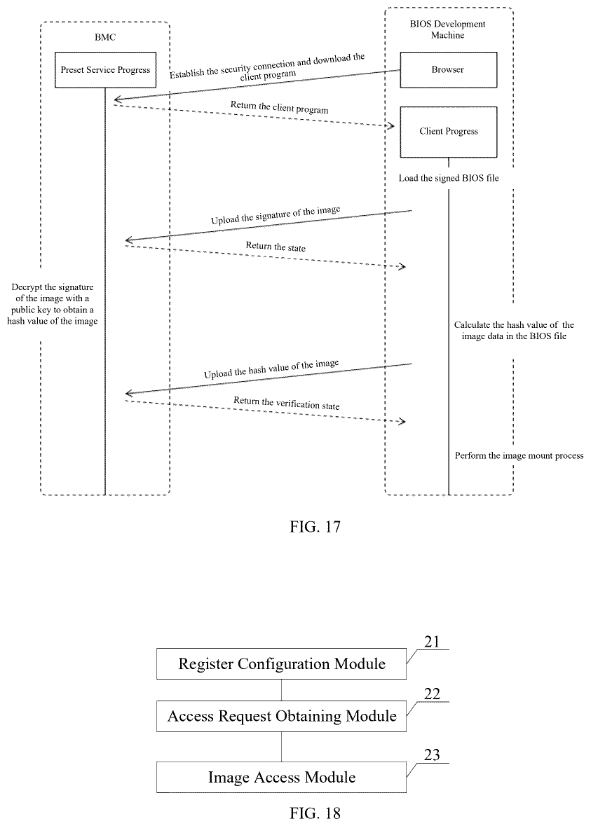

Referring to FIG. 17, FIG. 17 is a schematic diagram of a security mechanism disclosed in some embodiments of the present disclosure. The working mode is as follows: 1) a user establishes a security connection with a preset service on a BMC through a browser on a BIOS development machine, downloads a client program and executes the client program; 2) the user loads a signed BIOS file through a client process; 3) the client process uploads a signature of a BIOS image to a preset service process of the BMC; 4) the preset service process decrypts the signature using a public key; 5) a client process calculates a hash (an algorithm) value of data in the BIOS image in a BIOS file; 6) a client uploads the hash value to the preset service process on the BMC, the preset service process performs corresponding verification and obtains a verification result; 7) if the verification passes, a subsequent BIOS image attaching flow is executed.

It can be seen that in the present disclosure, by implementing a new BMC chip architecture, the problem of low debugging efficiency of the BIOS in the original solution may be solved, and remote, convenient and efficient debugging of the BIOS may be supported. The BMC may completely control a data bus connected between a host (Host) and the Flash, and flexibly map a Flash request of the Host to a variety of targets, including a DRAM (a computer memory technology) and a network. When the request is mapped to the BIOS area in the DRAM, a new BIOS may be quickly deployed through the network by developing and debugging the BIOS. Moreover, it is transparent to a CPU side and does not need to make any changes on the CPU side. Further, it is transparent to BIOS firmware codes and does not need to make any changes on the BIOS firmware codes. In addition, the method disclosed in the present disclosure may be used in a scenario where the BMC serves as a system root of trust, thereby achieving a purpose of the BMC monitoring and controlling the bus between the Host and the Flash. Furthermore, the method may be applied to a scenario of debugging a dual BIOS Flash. The method may record all access logs of the BIOS Flash.

Referring to FIG. 18, there is provided a basic input/output system debugging apparatus in some embodiments of the present disclosure. The apparatus is applied to a baseboard management controller, where the baseboard management controller is connected to a central processing unit through a target bus, a basic input/output system flash memory and a dynamic random access memory are hooked on a system bus of the baseboard management controller, and the apparatus includes:
a register configuration module 21 configured to configure a first address range to a preset register, where the first address range is an address range of a first basic input/output system image in the dynamic random access memory in a bus address space of the system bus;
an access request obtaining module 22 configured to obtain an access request for the basic input/output system flash memory sent by the central processing unit through the target bus; and
an image access module 23 configured to access the first basic input/output system image in the dynamic random access memory based on the first address range to realize debugging of a basic input/output system.

It can be seen that in some embodiments of the present disclosure,
the central processing unit is controlled by the baseboard management controller to be connected to the data bus of the basic input/output system flash memory, and the access request of the central processing unit is mapped to the dynamic random access memory, thereby realizing the debugging of the basic input/output system. In this way, it is not necessary to remove or plug the flash memory into the programmer or use the special fixture to refresh the basic input/output system, and it is not necessary to erase the flash memory first and then write the flash memory, thereby avoiding the problem that the refreshing of the basic input/output system takes a long time, and improving the debugging efficiency of the basic input/output system.

In an implementation manner, the apparatus further includes:
a basic input/output system image creation module configured to obtain the first basic input/output system image through an out-of-band interface of the baseboard management controller, and store the first basic input/output system image to the dynamic random access memory.

In an implementation manner, the apparatus further includes:
an layout information parsing module configured to parse layout information of the first basic input/output system image, where the layout information includes position information and size information on non-transitory data sections;
a data backup module configured to back up data of the non-transitory data sections in the first basic input/output system image based on the layout information to obtain backup data; and
a default value recovery module configured to overwrite current data of the non-transitory data sections in the first basic input/output system image based on the backup data in response to obtaining a default value recovery request.

In an implementation manner, the apparatus further includes:
a first security verification module configured to obtain a signature of the first basic input/output system image uploaded by a user terminal, where the signature is obtained by encrypting a hash value of the first basic input/output system image using an encrypted private key; decrypt the signature using a public key to obtain decrypted data; and obtain a hash value of the first basic input/output system image uploaded by the user terminal, verify the hash value using the decrypted data, and trigger the step of obtaining the first basic input/output system image through the out-of-band interface of the baseboard management controller in response to a success of the verifying.

In response to the dynamic random access memory including different first basic input/output system images, the register configuration module 21 is further configured to configure a plurality of groups of preset registers based on address ranges of the different first basic input/output system images in the bus address space; and set a preset register corresponding to a chip select signal to be valid based on the chip select signal enabled by the central processing unit; the access request obtaining module 22 is configured to obtain the access request sent by the central processing unit; and the image access module 23 is configured to access a first basic input/output system image corresponding to the valid preset register in the dynamic random access memory.

In another implementation manner, the apparatus further includes:
a virtual image creation module configured to create a virtual basic input/output system image in the dynamic random access memory as the first basic input/output system image.

The apparatus is further configured to in response to the access request being a read request, send a first interrupt notification to a preset service to send a data request to a user terminal through the preset service, obtain read data returned by the user terminal, and write the read data into the first basic input/output system image; where the read data is data read from a second basic input/output system image, and the second basic input/output system image is an image preloaded into a memory by the user terminal. The apparatus is further configured to in response to the access request being a write request, write data carried in the write request into the first basic input/output system image, send a second interrupt notification to a preset service to read the write data from the first basic input/output system image through the preset service and send the write data to the user terminal to enable the user terminal to write the write data into a second basic input/output system image preloaded into a memory of the user terminal.

In an implementation manner, the apparatus further includes an access request collection module configured to collect all the access requests through a preset service, and send the access requests to a user terminal to enable the user terminal to log based on the access requests.

In an implementation manner, the apparatus further includes:
a second security verification module configured to obtain a signature of the second basic input/output system image uploaded by the user terminal, where the signature is obtained by encrypting a hash value of the second basic input/output system image using an encrypted private key; decrypt the signature using a public key to obtain decrypted data; and obtain a hash value of the second basic input/output system image uploaded by the user terminal, verify the hash value using the decrypted data, and trigger the step of creating the virtual basic input/output system image in the dynamic random access memory in response to a success of the verifying.

In an implementation manner, the second security verification module is further configured to receive a client program download request sent by the user terminal, and return a client program in response to the client program download request; and obtain the signature of the second basic input/output system image uploaded by a client through the preset service, where the client is a client launched by the user terminal based on the client program.

In a specific implementation manner, a memory controller is hooked on the system bus, the dynamic random access memory is hooked on the memory controller, and the image access module 23 is configured to send the access request to the memory controller, and access the first basic input/output system image in the dynamic random access memory through the memory controller.

In an implementation manner, the apparatus is further configured to in response to the preset register being in a default configuration, obtain the access request for the basic input/output system flash memory sent by the central processing unit through the target bus, and access the basic input/output system flash memory.

In a specific implementation manner, a flash memory controller is hooked on the system bus, the basic input/output system flash memory is hooked on the flash memory controller, the apparatus is configured to send the access request to the flash memory controller, and access the basic input/output system flash memory through the flash memory controller.

In an implementation manner, the apparatus further includes an out-of-band refresh module configured to obtain the first basic input/output system image through an out-of-band interface of the baseboard management controller, and store the first basic input/output system image to the dynamic random access memory; and program the flash memory controller to write the first basic input/output system image in the dynamic random access memory into the basic input/output system flash memory.

In an implementation manner, the apparatus further includes a flash memory fast access module configured to fetch data in the basic input/output system flash memory into the dynamic random access memory, and establish a third basic input/output system image in the dynamic random access memory based on the data; configure a second address range of the third basic input/output system image in the bus address space to the preset register; and access the third basic input/output system image in the dynamic random access memory based on the second address range in response to obtaining the access request for the basic input/output system flash memory sent by the central processing unit.

In an implementation manner, the apparatus is further configured to map different basic input/output system flash memories to the bus address space of the system bus, where address ranges of the different basic input/output system flash memories in the bus address space are different; configure a plurality of groups of preset registers based on the address ranges of the different basic input/output system flash memories in the bus address space; set a preset register corresponding to a chip select signal to be valid based on the chip select signal enabled by the central processing unit; and obtain the access request sent by the central processing unit, and access a basic input/output system flash memory corresponding to the valid preset register.

In an implementation manner, a network controller is hooked on the system bus and is configured to interconnect with an external network.

In an implementation manner, a bus agent is hooked on the system bus, the bus agent is connected to the central processing unit through the target bus, and the bus agent is configured to configure the preset register through the bus agent, obtain the access request sent by the central processing unit, and forward the access request to a corresponding component hooked on the system bus based on the configuration of the preset register.

Various embodiments in the specification are described in a progressive manner, each embodiment focuses on the difference from other embodiments, and the same and similar parts of various embodiments can be referred to each other. The apparatus disclosed in the embodiments are substantially similar to the method embodiments, and thus the description is relatively simple, and the relevant points can be found in part of the description of the method embodiments.

Steps of a method or algorithm described in connection with the embodiments disclosed herein may be directly implemented in hardware, a software module executed by a processor, or a combination thereof. The software module may be placed in a random access memory (RAM), a memory, a read only memory (ROM), an electrically programmable ROM, an electrically erasable programmable ROM, a register, a hard disk, a removable disk, a compact disk read only memory (CD-ROM), or any other form of nonvolatile readable storage medium known in the art.

The baseboard management controller, and a basic input/output system debugging method and apparatus provided by the present disclosure are described in detail as above. The principles and embodiments of the present disclosure are described with the specific examples. The descriptions of the above embodiments are only for helping to understand the method and core ideas of the present disclosure. At the same time, for a person of ordinary skill in the art, according to the ideas of the present disclosure, there may be changes in specific embodiments and application scopes. In summary, contents of the specification should not be understood as limiting the present disclosure.

1. A baseboard management controller, comprising:
a target bus connected to a central processing unit and configured to obtain an access request sent by the central processing unit;
a system bus and a dynamic random access memory hooked on the system bus, wherein the dynamic random access memory is configured to store a first basic input/output system image; and
a bus agent hooked on the system bus and configured to configure a first address range to a preset register and forward the access request to a memory controller hooked on the system bus based on the first address range, wherein the first address range is an address range of the first basic input/output system image in a bus address space of the system bus; and
the memory controller is configured to access the first basic input/output system image in the dynamic random access memory.

2. The baseboard management controller according to claim 1, further comprising:
a network controller hooked on the system bus and configured to obtain the first basic input/output system image through an out-of-band interface of the baseboard management controller; and
a core component hooked on the system bus and configured to store the first basic input/output system image to the dynamic random access memory.

3. The baseboard management controller according to claim 1, further comprising:
a core component hooked on the system bus and configured to create a virtual basic input/output system image in the dynamic random access memory as the first basic input/output system image.

4. The baseboard management controller according to claim 3, wherein the bus agent is further configured to:
in response to the access request being a read request, send an first interrupt notification to a preset service in the core component to send a data request to a user terminal through the preset service;
the baseboard management controller further comprises: a network controller hooked on the system bus and configured to obtain read data returned by the user terminal; and the core component is further configured to write the read data into the first basic input/output system image, wherein the read data is data read from a second basic input/output system image, and the second basic input/output system image is an image preloaded into a memory by the user terminal.

5. The baseboard management controller according to claim 4, wherein the bus agent is further configured to:
in response to the access request being a write request, write write data carried in the write request into the first basic input/output system image and send an second interrupt notification to the preset service in the core component to read the write data from the first basic input/output system image through the preset service and send the write data to the user terminal to enable the user terminal to write the write data into the second basic input/output system image preloaded into the memory of the user terminal.

6. The baseboard management controller according to claim 2, further comprising:
a flash memory controller hooked on the system bus and configured to access a basic input/output system flash memory hooked on the flash memory controller.

7. The baseboard management controller according to claim 6, wherein the core component is further configured to program the flash memory controller to write the first basic input/output system image in the dynamic random access memory into the basic input/output system flash memory.

8. The baseboard management controller according to claim 6, wherein the core component is further configured to:
fetch data in the basic input/output system flash memory into the dynamic random access memory, and establish a third basic input/output system image in the dynamic random access memory based on the data;
configure a second address range of the third basic input/output system image in the bus address space to the preset register; and
access the third basic input/output system image in the dynamic random access memory based on the second address range in response to obtaining an access request for the basic input/output system flash memory sent by the central processing unit.

9. A basic input/output system debugging method, applied to a baseboard management controller, wherein the baseboard management controller is connected to a central processing unit through a target bus, and a basic input/output system flash memory and a dynamic random access memory are hooked on a system bus of the baseboard management controller, the method comprising:
configuring a first address range to a preset register, wherein the first address range is an address range of a first basic input/output system image in the dynamic random access memory in a bus address space of the system bus; and
in response to obtaining an access request for the basic input/output system flash memory sent by the central processing unit through the target bus, accessing the first basic input/output system image in the dynamic random access memory based on the first address range to realize debugging of a basic input/output system.

10. The basic input/output system debugging method according to claim 9, wherein before configuring the first address range to the preset register, the method further comprises:
obtaining the first basic input/output system image through an out-of-band interface of the baseboard management controller, and storing the first basic input/output system image to the dynamic random access memory.

11. The basic input/output system debugging method according to claim 10, wherein after obtaining the first basic input/output system image, the method further comprises:
parsing layout information of the first basic input/output system image, wherein the layout information comprises position information and size information on non-transitory data sections;
backing up data of the non-transitory data sections in the first basic input/output system image based on the layout information to obtain backup data; and
overwriting current data of the non-transitory data sections in the first basic input/output system image based on the backup data in response to obtaining a default value recovery request.

12. The basic input/output system debugging method according to claim 10, further comprising:
obtaining a signature of the first basic input/output system image uploaded by a user terminal, wherein the signature is obtained by encrypting a hash value of the first basic input/output system image using an encrypted private key;
decrypting the signature using a public key to obtain decrypted data; and
obtaining a hash value of the first basic input/output system image uploaded by the user terminal, verifying the hash value using the decrypted data, and triggering the step of obtaining the first basic input/output system image through the out-of-band interface of the baseboard management controller in response to a success of the verifying.

13. The basic input/output system debugging method according to claim 9, further comprising:
in response to the dynamic random access memory comprising different first basic input/output system images,
configuring a plurality of groups of preset registers based on address ranges of the different first basic input/output system images in the bus address space;
setting a preset register corresponding to a chip select signal to be valid based on the chip select signal enabled by the central processing unit; and
obtaining the access request sent by the central processing unit, and accessing a first basic input/output system image corresponding to the valid preset register in the dynamic random access memory.

14. The basic input/output system debugging method according to claim 9, wherein before configuring the first address range to the preset register, the method further comprises:
creating a virtual basic input/output system image in the dynamic random access memory as the first basic input/output system image.

15-19. (canceled)

20. The basic input/output system debugging method according to claim 9, wherein a memory controller is hooked on the system bus, the dynamic random access memory is hooked on the memory controller, and accessing the first basic input/output system image in the dynamic random access memory based on the first address range comprises:
sending the access request to the memory controller, and accessing the first basic input/output system image in the dynamic random access memory through the memory controller.

21. The basic input/output system debugging method according to claim 9, further comprising:
in response to the preset register being in a default configuration, obtaining the access request for the basic input/output system flash memory sent by the central processing unit through the target bus, and accessing the basic input/output system flash memory.

22-23. (canceled)

24. The basic input/output system debugging method according to claim 9, further comprising:
fetching data in the basic input/output system flash memory into the dynamic random access memory, and establishing a third basic input/output system image in the dynamic random access memory based on the data;
configuring a second address range of the third basic input/output system image in the bus address space to the preset register; and
accessing the third basic input/output system image in the dynamic random access memory based on the second address range in response to obtaining the access request for the basic input/output system flash memory sent by the central processing unit.

25. The basic input/output system debugging method according to claim 9, further comprising:
mapping different basic input/output system flash memories to the bus address space of the system bus, wherein address ranges of the different basic input/output system flash memories in the bus address space are different;
configuring a plurality of groups of preset registers based on the address ranges of the different basic input/output system flash memories in the bus address space;
setting a preset register corresponding to a chip select signal to be valid based on the chip select signal enabled by the central processing unit; and
obtaining the access request sent by the central processing unit, and accessing a basic input/output system flash memory corresponding to the valid preset register.

26. The basic input/output system debugging method according to claim 9, wherein a network controller is hooked on the system bus and is configured to interconnect with an external network.

27. The basic input/output system debugging method according to claim 9, wherein a bus agent is hooked on the system bus, the bus agent is connected to the central processing unit through the target bus, and the method further comprises:
configuring the preset register through the bus agent, obtaining the access request sent by the central processing unit, and forwarding the access request to a corresponding component hooked on the system bus based on the configuration of the preset register.

28. (canceled)
